(19) United States
(12) Patent Application Publication
(10) Pub. No.: US 2023/0021064 A1
(43) Pub. Date: Jan. 19, 2023

(54) HOB DEVICE

(71) Applicant: BSH Hausgeräte GmbH, Munich (DE)

(72) Inventors: Enrique Carretero Chamarro, Zaragoza (ES); Ana Elduque Viñuales, Huesca (ES); Javier Lasobras Bernad, EJEA DE LOS CABALLEROS (ZARAGOZA) (ES); Damaso Martin Gomez, Zaragoza (ES); Pilar Perez Cabeza, Zaragoza (ES); Julio Rivera Peman, Cuarte de Huerva (Zaragoza) (ES); Ander Villate Robles, Zaragoza (ES)

(21) Appl. No.: 17/790,967

(22) PCT Filed: Jan. 13, 2021
(86) PCT No.: PCT/EP2021/050541

§ 371 Date: Jul. 6, 2022

(30) Foreign Application Priority Data
Jan. 31, 2020 (EP) 20382062.6

(51) Int. Cl. H05B 6/12

(52) U.S. Cl. CPC H05B 6/1218

(57) ABSTRACT

A hob apparatus includes a hob plate having a cooking region, a light source unit including a light source for providing light, and a fiber optic unit including an optical fiber for transmitting the light into at least one region that surrounds the cooking region. The optical fiber includes an end region which contacts the hob plate.

The invention relates to a hob apparatus as claimed in the preamble of claim 1 and a method for assembling a hob apparatus as claimed in the preamble of claim 13.

The publication WO 2019/011586 A1 already discloses a hob apparatus having at least one hob plate, having at least one heating element, having at least one light providing unit that is arranged on a side of the heating element that is remote from the hob plate and that provides light in at least one operating state, and having a wave guide unit that in the operating state transports light from the light providing unit to a side of the heating element that is facing the hob plate.

The object of the invention in particular resides in, however is not limited to, providing an apparatus of the generic type having improved characteristics with regard to efficiency. The object is achieved in accordance with the invention by the features of claims 1 and 13, while advantageous embodiments and developments of the invention are apparent in the dependent claims.

The invention is based on a hob apparatus, in particular induction hob apparatus, having at least one hob plate that has at least one cooking region, having at least one light source unit, comprising at least one light source for providing light, and having at least one fiber optic unit that comprises at least one optical fiber for transmitting the light in particular into at least one region that surrounds the cooking region.

It is proposed that an end region of the optical fiber contacts the hob plate.

It is advantageously possible owing to an embodiment of this type to increase an efficiency of an illumination of the cooking region and/or the surrounding region. In particular, it is advantageously possible to minimize light losses that can be caused in the case of conventional hobs in particular on account of a gap between the optical fiber and the hob plate. Moreover, it is possible to illuminate symbols on the hob plate in a particularly precise manner and to prevent undesired light scattering whereby opaque coatings of the hob plate can be further advantageously omitted and consequently production costs can be reduced and/or an aesthetic of the hob plate can be improved. Furthermore, it is advantageously possible to omit a light diffusion layer in the hob plate since a diffusion of the light directly onto a contact surface is rendered possible between the optical fiber and the hob plate, whereby costs can be further reduced. Moreover, it is advantageously possible to compensate production tolerances of components whereby in particular material waste can be reduced and consequently production costs can be reduced. It is possible owing to the mentioned advantages for a user to be provided with a particularly energy efficient and/or inexpensive and/or aesthetic hob apparatus having a particularly high functionality.

In a further aspect of the invention that can be viewed in particular both independently of the first aspect as well as in combination with the first aspect of the invention it is proposed that the light source unit is arranged below a region of the hob plate that lies outside the surrounding region and the cooking region.

Owing to this further aspect of the invention it is advantageously possible to achieve an in particular efficient and/or cost-effective illumination of the cooking region and/or the surrounding region. In particular, owing to the arrangement of the light source unit outside the surrounding region and the cooking region it is rendered possible to use light sources, in particular LEDs, having less strict requirements in comparison to the prior art with regard to temperature resistance whereby particularly advantageously light sources having a particularly high degree of light efficiency can be used. As a consequence, it is moreover advantageously possible to use a switching power supply that is designed for a lower rated power than would be the case in the case of conventional LEDs or other light sources. Consequently, it is advantageously possible to reduce production costs and to provide a particularly inexpensive hob apparatus. Moreover, it is also rendered possible to use RGB LEDs owing to lower temperature loads of the light source whereby a functionality of the hob apparatus can be advantageously increased for example owing to in each case different color illumination of the surrounding region in different operating situations of the hob apparatus. As a consequence, it is possible to advantageously improve an ease of operation and/or an operator experience for users. Users profit moreover from the advantageous energy saving and/or resource preserving characteristics of the hob apparatus. Owing to the arrangement of the light source units in accordance with the invention moreover a greater variety of possibilities is advantageously provided with regard to a particularly aesthetic design of the hob apparatus.

The term a “hob apparatus”, in particular the term an “induction hob apparatus”, is to be understood to mean in particular at least a part, in particular a sub assembly, of a hob, in particular an induction hob, wherein in particular in addition accessory units can also be included for the hob such as for example a sensor unit for the external measurement of a temperature of an item of cookware and/or an item of food. In particular, the hob apparatus, in particular the induction hob apparatus, can also comprise the entire hob, in particular the entire induction hob. The hob apparatus in an alternative to an induction hob apparatus can be in particular at least a part, in particular a sub assembly, of a glass ceramic electric hob or a mass hob or a gas hob and in particular can also comprise the entire glass ceramic electric hob or the entire mass hob or the entire gas hob.

The term a “hob plate” is to be understood to mean in particular a unit that is provided in at least one operating state for a placement of an item of cookware and that is in particular provided so as to embody a part of a hob outer housing, in particular the hob apparatus and/or a hob that has the hob apparatus. In particular, in an installed position the hob plate provides a part of the hob outer housing that faces an operator. The hob plate is embodied in particular at least to a large extent from glass and/or glass ceramic. Alternatively, the hob plate could be embodied from other suitable materials that are known to the person skilled in the art. It is in particular feasible that the hob plate is embodied from an at least in part coated material. The term “at least to a large extent” is to be understood to mean in particular a proportion, in particular a mass proportion and/or volume proportion, of at least 70 %, in particular of at least 80 %, advantageously of at least 90 % and preferably of at least 95 %.

The term a “light source unit” is to be understood to mean in particular a unit that has at least one light source and that provides light, in particular visible light, in at least one operating state, in particular by means of the light source. In particular, the light source unit has at least two, in particular at least four, advantageously at least eight, particularly advantageously at least twelve and preferably a plurality of light sources. At least one light source of the light source unit could be provided for example as a, preferably backlit, display unit, in particular a light source that is designed as a matrix display unit, preferably as an LCD display or as an OLED display. In particular, at least one light source of the light providing unit, advantageously at least a majority of the light sources, preferably all the light sources of the light source unit is designed as an LED. The term “visible light” is to be understood to mean in particular electromagnetic radiation from a wavelength range of 380 nm to 780 nm.

The term a “fiber optic unit” is to be understood to mean in particular a unit that comprises at least one optical fiber and that in particular in at least one operating state is provided so as to transport light, in particular visible light, in particular in a precise and/or targeted manner, from a first region into at least a second region that is different from and/or spaced from the first region, in particular from a region of the light source unit into at least one surrounding region of the cooking region. The term an “optical fiber” is to be understood to mean in particular an element that in at least one operating state transmits, in particular transports, electromagnetic radiation, in particular visible light and/or infrared radiation, advantageously both visible light as well as infrared radiation, in the longitudinal extent direction of the optical fiber preferably via total reflection within the optical fiber. In particular, the optical fiber in at least one operating state at least essentially prevents at least electromagnetic radiation entering and/or exiting in directions that are at least essentially oriented in a perpendicular manner with respect to the longitudinal extent direction of the optical fiber. In particular, the fiber optic unit has at least two, in particular at least four, advantageously at least eight, particularly advantageously at least twelve and preferably a plurality of optical fibers. It is preferred that a number of optical fibers corresponds to a number of light sources and in particular each light source of the light source unit is allocated precisely one optical fiber. The term a “longitudinal extent direction” of an object is to be understood to mean in particular a direction that is oriented parallel with respect to a longest side of a smallest conceived geometric cuboid that only just entirely encompasses the object. The expression “essentially in a perpendicular manner” is to define in this case in particular an orientation of a direction relative to a reference direction, wherein the direction and the reference direction, in particular when viewed in a plane, include an angle of 90° and the angle advantageously has a maximum deviation of in particular less than 8°, advantageously less than 5° and particularly advantageously less than 2°.

The term a “cooking region” is to be understood to mean in particular a part region of the hob apparatus, in particular a part region of the hob plate that is provided for the placement of at least one item of cookware and for heating at least one item of food that is located in the item of cookware. In particular, at least one heating element, in particular at least one induction heating element is arranged below the cooking region, in particular on a side of the hob plate that in a mounted state of the hob apparatus is remote from the user, and said heating element in at least one operating state provides a heating energy so as to heat the cooking region and/or an item of cookware that is placed on the cooking region and/or an item of food that is located within the item of cookware. The heating element can in particular be a part of the hob apparatus. Alternatively, the heating element can be part of a hob that has the hob apparatus.

The term a “region surrounding the cooking region” is to be understood to mean in particular a region of the hob plate that comprises at least the entire cooking region and that in addition can comprise a surface that surrounds the cooking region and the outer limitation of said surface has a shortest distance to an outer limitation of the cooking region of at least 1 cm, in particular of at least 2 cm, advantageously of at least 2.5 cm, and of at most 7 cm, in particular of at most 5 cm, advantageously of at most 4 cm.

The term “below” is in reference to the hob plate, in particular to an installed position of the hob plate. In an installed position of the hob plate, a region above the hob plate is facing a user with a viewing direction that is perpendicular to a main extent plane of the hob plate while the region below the hob plate is located on the side that lies above opposite the region and is remote from the user.

The term a “main extent plane” of a unit is to be understood to mean in particular a plane that is parallel to a largest side surface of a smallest conceived cuboid that only just encompasses the object, and in particular extends through the center point of the cuboid.

The term an “end region” of the optical fiber is to be understood to mean in particular a region of the optical fiber that comprises at least a point and/or a surface of the optical fiber and the light that is transmitted and/or transported through the optical fiber exits the optical fiber through said surface and/or point of the optical fiber and said optical fiber extends from this point and/or this surface in the radial direction of the optical fiber to an outer surface of the optical fiber. The end region extends starting from the point and/or the surface of the optical fiber and the light that is transmitted and/or transported through the optical fiber exits from the optical fiber through said point and/or surface in the direction of a longitudinal extent of the optical fiber, in particular by a length between 0.1 % and 5 % of an entire longitudinal extent of the optical fiber. The end region extends starting from the point and/or the surface of the optical fiber and the light that is transmitted and/or transported through the optical fiber exits through said point and/or surface in the direction of the longitudinal extent of the optical fiber, in particular by a length of at least 1 mm.

The fact that a first object “contacts” a second object is to be understood to mean in particular that a spacing between the first and second object is negligible in the region of the contacting arrangement and in particular is zero.

The term “provided” is to be understood to mean in particular specifically designed and/or equipped. The fact that an object is provided for a specific function is in particular to be understood to mean that the object fulfils and/or performs this specific function in at least one application and/or operating state.

Moreover, it is proposed that the region is an edge region of the hob plate. As a consequence, it is advantageously possible to further reduce, in particular to minimize, requirements of the light source with regard to a temperature resistance whereby it is rendered possible to use LEDs that are particularly light efficient. The term an “edge region” is to be understood to mean in particular a region below the hob plate that extends in a direction parallel to the main extent plane of the hob plate starting from at least one outer edge of the hob plate by at most 10 cm, in particular by at most 8 cm, advantageously by at most 7 cm, preferably by at most 6 cm and particularly preferably by at most 5 cm in the direction of a central line of the hob plate that extends through a central point of the hob plate. It is preferred that the edge region is arranged spaced to the maximum extent with respect to the surrounding region.

Moreover, it is proposed that the hob apparatus has a fastening unit for fastening the fiber optic unit below the hob plate. As a consequence, it is advantageously rendered possible to fasten the fiber optic unit below the hob plate using simple technical means. The fastening unit forms in particular a fastening region and the fiber optic unit, in particular the optical fiber of the fiber optic unit, is fastened in said fastening region. A fastening of the fiber optic unit in the fastening region of the fastening unit can be realized in particular by means of a positive-locking and/or non-positive locking and/or materially bonded connection. For example, it is feasible that the fiber optic unit is adhesively bonded or welded in a materially bonded manner to the fastening unit in the fastening region. Alternatively or in addition, it is feasible that the fastening unit has at least one fastening element and the fiber optic unit is fastened to the fastening unit in a positive-locking and/or non-positive locking manner, for example via a latching connection and/or plug connection and/or by means of a screw connection.

Furthermore, it is proposed that the fastening unit is part of a shielding unit that is provided so as to shield an electromagnetic field. As a consequence, it is advantageously possible to reduce a number of components. Moreover, it is possible to advantageously achieve an arrangement of the fastening unit that saves space and consequently to achieve a particularly compact construction of the hob apparatus. The term a “shielding unit” is to be understood to mean in particular a unit that is provided so as to shield in particular electrical and/or electronic components of the hob apparatus and/or of the hob that has the hob apparatus, said components being arranged outside the shielding unit, in particular below a heating unit of the hob apparatus and/or the hob that has the hob apparatus, for example to shield a control unit, with respect to an electromagnetic field that is generated by at least the heating unit, in particular by at least an induction heating element of the heating unit, of the hob apparatus and/or of the hob that has the hob apparatus.

Furthermore, it is proposed that the optical fiber is arranged in a self-supporting manner starting from a fastening region on the fastening unit. As a consequence, it is advantageously possible to improve an assembly of the optical fiber. In particular, it is advantageously possible to reduce, in particular to minimize, a number of fastening elements of the fastening unit whereby in particular material costs and/or assembly costs can be reduced. In particular, a section of the optical fiber that comprises the end region of the optical fiber is arranged in a self-supporting manner. The fact that the optical fiber and in particular the section of the optical fiber that comprises the end region of the optical fiber is “arranged in a self-supporting manner” is to be understood to mean in this context in particular that the optical fiber extends and/or protrudes and/or projects starting from the fastening region in which the optical fiber is fastened by means of at least one fastening element of the fastening unit into a further region that lies outside the fastening region, in particular in the direction of the hob plate, and is arranged in this further region without additional fastening elements, wherein the optical fiber in this region in particular has a sufficient stability in order to at least essentially permanently maintain the arrangement in the further region. The end region of the optical fiber is contacted, in particular permanently, using the hob plate, in particular without an additional fastening arrangement.

Moreover, it is proposed that the optical fiber is provided in an at least essentially dimensionally stable and elastic manner. As a consequence, it is possible to advantageously improve an assembly of the optical fiber. The assembly of the optical fiber can be improved in particular in that on the one hand, in particular owing to the elastic characteristics of the optical fiber, a flexibility of the optical fiber is rendered possible and a risk of damage to the optical fiber can be reduced while, in particular owing to the dimensionally stable characteristics of the optical fiber, it is simultaneously possible to achieve a particularly efficient assembly, in particular using a particularly low number of fastening elements. Moreover, it is advantageously possible to provide a particularly durable optical fiber. In particular, the optical fiber has a flexibility that is selected so that, in particular for assembly, the optical fiber is sufficiently elastically deformable, in particular bendable, and in an assembled state is simultaneously sufficiently dimensionally stable and in order to maintain a provided arrangement. In particular, the optical fiber has a material and/or is at least essentially embodied from a material and the modulus of elasticity of said material is selected in particular in dependence upon a diameter of the optical fiber so that the optical fiber is sufficiently elastically deformable and simultaneously dimensionally stable. In particular, the optical fiber has a material having a modulus of elasticity between 2.500 MPa and 4.500 MPa. It is preferred that the optical fiber is at least essentially embodied from a material having a modulus of elasticity between 2.500 MPa and 4.500 MPa.

Furthermore, it is proposed that the optical fiber has a temperature resistance of at least 230° C. It is preferred that the optical fiber has a temperature resistance of at least 250° C. As a consequence, it is advantageously possible to provide an in particular reliable and/or durable hob apparatus. The term a “temperature resistance” of an object and/or material is to be understood to mean in particular an object specific and/or material specific temperature and/or an object specific and/or material specific temperature range that the object and/or material can be exposed to, in particular permanently and directly, without as a consequence changing the relevant object characteristics and/or material characteristics beyond an extent that is tolerable for the provided application and/or function of the object and/or material for a functionality of the object and/or material so as to fulfil a provided function. In particular, the object and/or material is functional and/or unimpaired and/or undamaged at the temperature and/or in the temperature range that defines the temperature resistance of the object and/or material. Owing to its temperature resistance, the optical fiber can be permanently and directly exposed to temperatures of at least 230° C. without as a consequence changing the characteristics of the optical fiber, in particular a transparency and/or an elasticity and/or a dimensional stability of the optical fiber, beyond an extent that is tolerable for the function of the optical fiber within the hob apparatus.

Moreover, it is proposed that the optical fiber has at least one transparent thermoplastic material, in particular a plastic from the material group of methacrylate polymer, preferably poly methyl methacrylate (PMMA), particularly preferably polymethyl methacrylimide (PMMI) and in particular is embodied from such a material. As a consequence, it is advantageously possible to improve a production process of the optical fiber. Moreover, it is possible to provide an optical fiber having particularly advantageous material characteristics. In particular, it is possible to provide an optical fiber having a high degree of light transmission and said optical fiber moreover simultaneously has a high degree of dimensional stability with simultaneously sufficient elasticity and also sufficient temperature resistance. Alternatively or in addition thereto, it is feasible that the optical fiber has another transparent plastic such as for example polycarbonate (PC) and/or polyvinyl chloride (PVC) and/or polystyrene (PS) and/or polyphenylene oxide (PPO) and/or polyethylene (PE), and in particular is embodied from such a material. The optical fiber can be produced in particular in a molding process that is suitable for the transparent thermoplastic material, in particular in a single or multiple component injection molding process or in an extrusion process. Moreover, it would alternatively or in addition be feasible that the optical fiber has a transparent inorganic material, for example glass and in particular is embodied from such a material.

Moreover, it is proposed that the optical fiber has an outer layer having a lower refractive index with respect to a core of the optical fiber. As a consequence, it is advantageously possible to reduce, in particular minimize, light losses. The term an “outer layer” is to be understood to mean in particular a layer that entirely surrounds the core of the optical fiber. The outer layer can be provided in particular as a single piece with the core of the optical fiber. Alternatively, the outer layer can be provided in particular as a coating, for example as a coating of silicon germanium. The outer layer could be applied to the core of the optical fiber as a coating by a coating method, in particular by a silk screen printing method, by spin coating, by dip painting (dip coating), by a Sol-Gel method, by spraying, by an inkjet printing method, by a chemical gas separating method (CVD: chemical vapor deposition) and/or by a physical gas separation method (PVD: physical vapor deposition). The outer layer could have and/or could be embodied from for example inorganic materials, in particular glass. It is preferred that the outer layer is produced from a plastic. It is particularly preferred that the core and the outer layer are produced from an essentially identical material, in particular in a two component injection molding process. The term “essentially identical material” is to be understood to mean in this context in particular that in relation to substance amount proportions, a composition of a first material deviates in relation to substance amount proportions from a composition of a second material in particular by less than 25 %, preferably by less than 10 % and particularly preferably by less than 5 %. For example, it would be feasible that the core of the optical fiber is embodied from a first poly methyl methacrylate (PMMA) and the outer layer is embodied from fluorinated PMMA having a lower refractive index with respect to the first PMMA. In particular, it would be feasible that the core of the optical fiber is embodied from a first poly methyl methacrylimide (PMMI) and the outer layer is embodied from a second PMMI having a reduced substance amount proportion of imide with respect to the first PMMI and consequently a lower refractive index.

Furthermore, it is proposed that the at least one light source is designed as an RGB LED. As a consequence, it is advantageously possible to increase a functionality of the hob apparatus. In particular, it would be feasible that by means of the RGB LED an illumination of the surrounding region in each case in different colors for respective different operating situations of the hob apparatus is rendered possible. Moreover, it could be rendered possible for a user to perform an individual adaptation of the illumination of the surrounding region, for example in their favorite color whereby an operator experience is advantageously improved and/or a user friendliness can be increased. Alternatively, it would be feasible that the at least one light source is designed as a single color LED.

Moreover it is proposed that the end region of the optical fiber has a purely convex shape. As a consequence, it is advantageously possible to achieve an in particular targeted illumination of a region that is to be illuminated, in particular at least a part region of the surrounding region, of the hob plate. Moreover, in particular it is possible to achieve a uniform illumination of the region that is to be illuminated whereby it is advantageously possible to omit a light diffusion layer in the hob plate. Moreover, it is advantageously possible to reduce light losses and to achieve an in particular energy efficient illumination of the region that is to be illuminated. Alternatively, it would be feasible that the end region does not have a curvature and is designed as a flat surface that contacts the cooking region.

Moreover, it is proposed that the fiber optic unit has at least one collimator so as to collimate the light that is provided by the light source. As a consequence, it is advantageously possible to achieve a particularly targeted and efficient illumination of a region that is to be illuminated. In particular, it is advantageously possible to further reduce light losses that can occur in particular in a transition between the light source and the optical fiber. The collimator can be designed in particular as a converging lens and can be arranged directly upstream of the optical fiber. It is possible by means of the collimator in particular for a beam path of a light that is emitted in a divergent manner from the light source to be parallelized and to be transmitted in a particularly targeted manner to the optical fiber.

Furthermore, it is proposed that a surface of the optical fiber is opaque outside the end region. As a consequence, it is advantageously possible to further reduce light losses. In particular, it is advantageously possible to reduce a light scatter. In particular, it is feasible that the optical fiber has an opaque coating outside the end region of the optical fiber. The opaque coating can be applied to the surface of the optical fiber by a coating method, in particular by a silk screen printing method, by spin coating, by dip painting (dip coating), by a Sol-Gel method, by spraying, by an inkjet printing method, by a chemical gas separating method (CVD: chemical vapor deposition) and/or by a physical gas separation method (PVD: physical vapor deposition).

Moreover, a method is proposed for assembling a hob apparatus having at least one hob plate that has at least one cooking region, having at least one light source unit, comprising at least one light source for providing light and having at least one fiber optic unit comprising at least one optical fiber for transmitting the light, wherein a self-supporting end region of the optical fiber is contacted by an underside of the hob plate during an installation of the hob plate and the optical fiber is deformed in an elastic manner by a subsequent lowering of the hob plate. As a consequence, it is advantageously possible to provide a particularly efficient method for assembling the hob apparatus.

The hob apparatus in this case is not to be limited to the above-described application and embodiment. In particular, the hob apparatus can have a number of individual elements, components and units that differs from the number mentioned herein so as to fulfil a function described herein.

Further advantages are apparent from the following description of the drawing. Exemplary embodiments of the invention are illustrated in the drawing. The drawing, the description and the claims contain numerous features in combination. The person skilled in the art will also expediently take the features into consideration individually and will combine said features to expedient further combinations.

In the drawings:

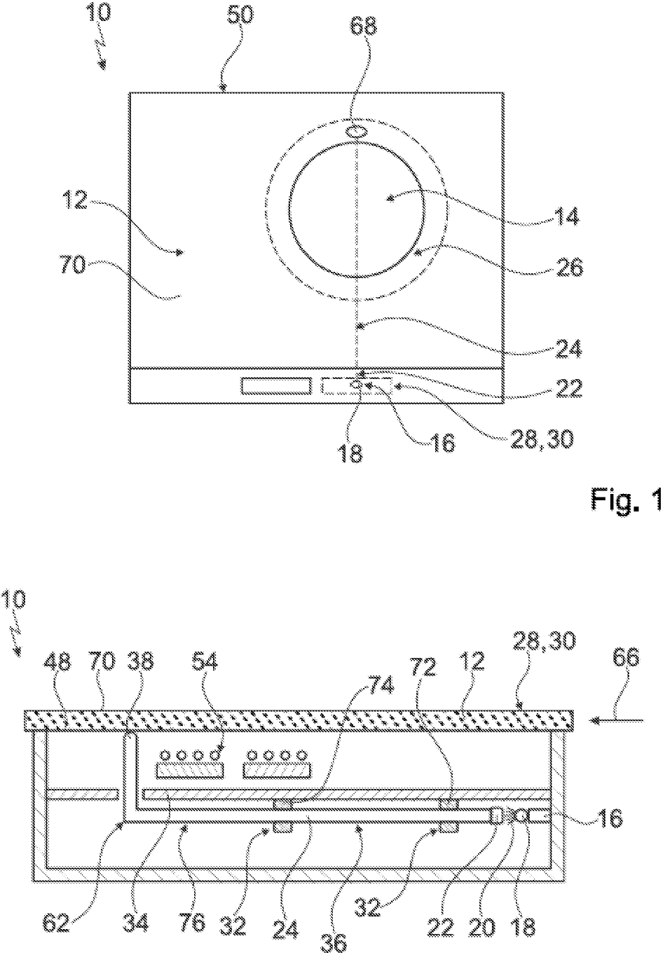

FIG. 1 shows a hob having a hob apparatus in a schematic plan view,

FIG. 2 shows the hob apparatus having a hob plate, a light source unit and a fiber optic unit in a schematic side sectional view,

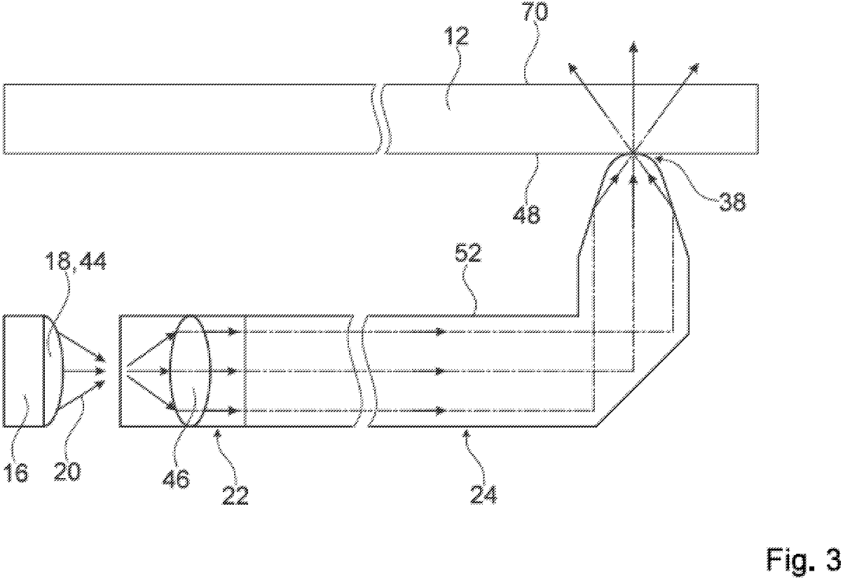

FIG. 3 shows an optical fiber of the fiber optic unit in a schematic side view,

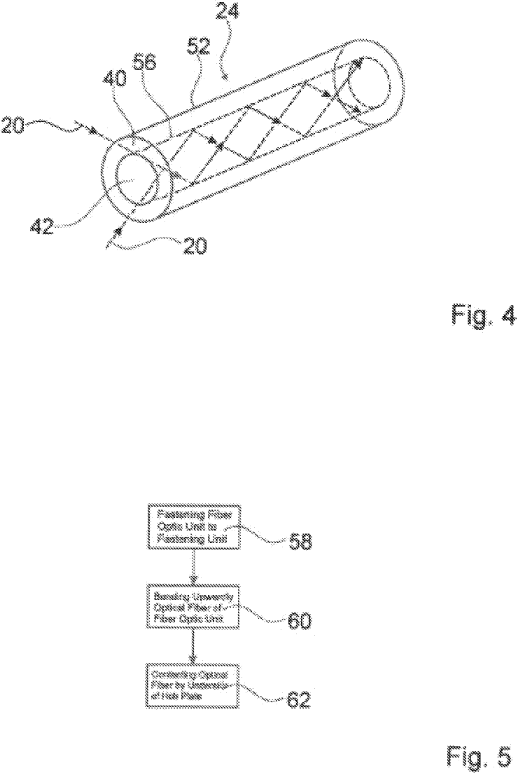

FIG. 4 shows the optical fiber in a schematic perspective view, and

FIG. 5 shows a schematic diagram so as to illustrate a method for assembling the hob apparatus.

FIG. 1 illustrates a hob 50 having a hob apparatus 10 in a schematic plan view. The hob apparatus 10 comprises a hob plate 12. The hob plate 12 is embodied from glass ceramic. The hob plate 12 has a cooking region 14. The cooking region 14 is arranged above a heating unit 54 of the hob 50 and said heating unit is designed as an inductor (cf. FIG. 2). The cooking region 14 is provided for a placement and heating of an item of cookware (not illustrated). A surrounding region 26 of the cooking region 14 is located around the cooking region 14.

The hob apparatus 10 comprises a light source unit 16 having a light source 18 for providing light 20. The light source 16 is arranged below a region 28 of the hob plate 12 that lies outside the surrounding region 26. The region 28 is an edge region 30 of the hob plate 12.

The hob apparatus 10 comprises a fiber optic unit 22 having an optical fiber 24. In an operating state of the hob apparatus 10, the optical fiber 24 transmits the light 20 that is provided by the light source 18 into the surrounding region 26 of the cooking region 14.

The hob apparatus 10 has a fastening unit 32. The fastening unit 32 is provided so as to fasten the fiber optic unit 22. The fastening unit 32 has a fastening region 36. The fastening unit 32 has a fastening element 72 and a further fastening element 74. The fastening element 72 and the further fastening element 74 are arranged in the fastening region 36. The fastening element 72 and the further fastening element 74 are designed in each case as clamps. The fastening element 72 and the further fastening element 74 encompass the optical fiber 24 in a circumferential direction in a positive-locking manner.

The fastening unit 32 is part of a shielding unit 34. The shielding unit 32 is provided so as to shield electrical and/or electronic components (not illustrated) of the hob apparatus 10 and/or the hob 50 with respect to an electromagnetic field that is generated by the heating unit 54.

The optical fiber 24 is fastened in the fastening region 36 to the fastening unit 32. Starting from the edge region 28 via the fastening region 36, an extent of the optical fiber 24 is essentially parallel to a main extent plane 66 of the hob plate. The optical fiber 24 of the fiber optic unit 22 is arranged in a self-supporting manner starting from the fastening region 36. The optical fiber 24 extends in a self-supporting manner from the further fastening element 74 in the fastening region 36 to a bending region 64. The optical fiber 24 is designed as at least essentially dimensionally stable and elastic. The optical fiber 24 is bent in an elastic manner in the bending region 64 in the direction of the hob plate 12 and extends from the bending region 64 in a dimensionally stable manner and essentially perpendicular with respect to a main extent plane 66 of the hob plate. The optical fiber exerts a pressing force in the direction of the hob plate 12 owing to the elastic bending of the optical fiber 24 in the bending region 64.

The optical fiber 24 consists of a transparent thermoplastic material and namely from poly methyl methacrylimide (PMMI). The optical fiber has a temperature resistance of at least 230° C.

FIG. 3 illustrates a schematic view of the light source unit 16, the fiber optic unit 22 and the hob plate 12. The light source 18 of the light source unit 16 is designed as an RGB LED 44. The fiber optic unit 22 has a collimator 46. The collimator 46 is provided so as to collimate the light 20 that is provided by the light source 18 of the light source unit 16. The collimator 46 is designed as a converging lens. When the light passes through the collimator 46, the light 20 that is emitted in a divergent manner by the light source is collimated.

The optical fiber 24 has an end region 38. The end region 38 contacts the hob plate 12 on an underside 48 of the hob plate 12. The contact between the end region 38 and the hob plate 12 is rendered possible in particular owing to the elastic bending of the optical fiber 24 in the bending region 64 (cf. FIG. 2).

The end region 38 of the optical fiber 24 has a purely convex shape. Owing to the purely convex shape of the end region 38, the light 20 is collected and focused. It is possible to realize a uniform illumination of a symbol 68 that is to be illuminated (cf. FIG. 1) in the surrounding region 26 on an upper side 70 of the hob plate 12.

A surface 52 of the optical fiber 24 is opaque outside the end region 38. In particular, the surface 52 of the optical fiber 24 is painted with a paint and is consequently opaque.

FIG. 4 illustrates the optical fiber 24 of the fiber optic unit 22 in a perspective schematic view. The optical fiber 24 has a core 42 and an outer layer 40. The core 42 transmits the light 20 that is provided by the light source 18 of the light source unit 16. The core 42 is surrounded by the outer layer 40. The outer layer 40 has a lower refractive index with respect to the core 42. The light 20 is reflected by means of total reflection on a boundary surface 56 between the core 40 and the outer layer 38.

FIG. 5 illustrates a diagram for a schematic illustration of a method for assembling the hob apparatus 10. The method comprises a first method step 58, a second method step 60 and a third method step 62. In the first method step 58, the fiber optic unit 22 is fastened to the fastening unit 32 in the fastening region 36. In the second method step 60, the optical fiber 24 is bent upward essentially at a right angle in the bending region 64. Owing to the bending of the optical fiber 24 in the bending region 64, the optical fiber 24 is deformed in an elastic manner in a deflection region 76 between the fastening region 36 and the bending region 64 (cf. FIG. 2). Owing to the elastic deformation in the deflection region 76, the optical fiber 24 is deflected in the direction of the shielding unit 34. The optical fiber 24 is deflected in the deflection region 76 at least in the direction of the shielding unit 34 so far that a longitudinal extent of the optical fiber 24 starting from the further fastening element 74 to the bending region 64 deviates at least by 2° from the main extent plane 66. Owing to the deflection of the optical fiber 24 in the direction of the shielding unit 34, the end region 38 of the optical fiber 24 protrudes in a self-supporting manner in a region in which the hob plate 12 is arranged. In the third method step 62, the self-supporting end region 38 of the optical fiber 24 is contacted by the underside 48 of the hob plate 12. When the hob plate 12 is lowered, the optical fiber is again deformed in an elastic manner with the result that the deflection of the optical fiber 24 in the deflection region 76 is eliminated to the greatest possible extent and the longitudinal extent of the optical fiber 24 extends starting from the further fastening element 74 to the bending region 64 essentially parallel to the main extent plane 66. Owing to the elastic deformation in the deflection region 76, the optical fiber exerts a pressing force on the hob plate 12 and presses against the underside 48 of the hob plate 12 with the result that a contact remains between the end region 38 and the underside 48 of the hob plate 12 after the hob plate has been entirely lowered and lies in the main extent plane 66.

### REFERENCE NUMERALS

10 Hob apparatus
12 Hob plate
14 Cooking region
16 Light source unit
18 Light source
20 Light
22 Fiber optic unit
24 Optical fiber
26 Surrounding region
28 Region
30 Edge region
32 Fastening unit
34 Shielding unit
36 Fastening region
38 End region
40 Outer layer
42 Core
44 RGB-LED
46 Collimator
48 Underside
50 Hob
52 Surface
54 Heating unit
56 Boundary surface
58 First method step
60 Second method step
62 Third method step
64 Bending region
66 Main extent plane
68 Symbol
70 Upper side
72 Fastening element
74 Further fastening element
76 Deflection region

1. -13. (canceled)

14. A hob apparatus, comprising:
a hob plate comprising a cooking region;
a light source unit comprising a light source for providing light; and
a fiber optic unit comprising an optical fiber for transmitting the light into at least one region that surrounds the cooking region, said optical fiber including an end region which contacts the hob plate.

15. The hob of claim 14, constructed in the form of an induction hob apparatus.

16. The hob apparatus of claim 14, wherein the optical fiber is designed as at least essentially dimensionally stable and elastic.

17. The hob apparatus of claim 14, further comprising a fastening unit designed to fasten the fiber optic unit below the hob plate.

18. The hob apparatus of claim 17, wherein the optical fiber is arranged in a self-supporting manner starting from a fastening region on the fastening unit.

19. The hob apparatus of claim 14, wherein the end region of the optical fiber has a purely convex shape.

20. The hob apparatus of claim 14, wherein the fiber optic unit comprises a collimator to collimate the light provided by the light source.

21. The hob apparatus of claim 14, wherein the optical fiber includes a surface which is opaque outside the end region.

22. The hob apparatus of claim 14, wherein the optical fiber includes a core and an outer layer, said outer layer having a refractive index which is lower than a refractive index of the core of the optical fiber.

23. The hob apparatus of claim 14, wherein the optical fiber includes a transparent and flexible thermoplastic material.

24. The hob apparatus of claim 23, wherein the transparent and flexible thermoplastic material is a plastic from the material group of methyl methacrylate polymers.

25. The hob apparatus of claim 14, wherein the optical fiber is made of a transparent and flexible thermoplastic material.

26. The hob apparatus of claim 25, wherein the transparent and flexible thermoplastic material is a plastic from the material group of methyl methacrylate polymers.

27. The hob apparatus of claim 14, wherein the optical fiber has a temperature resistance of at least 230° C.

28. The hob apparatus of claim 14, wherein the light source is designed as an RGB LED.

29. A hob, comprising a hob, said hob comprising a hob plate comprising a cooking region, a light source unit comprising a light source for providing light, and a fiber optic unit comprising an optical fiber for transmitting the light into at least one region that surrounds the cooking region, said optical fiber including an end region which contacts the hob plate.

30. A method for assembling a hob apparatus, said method comprising:
contacting a self-supporting end region of an optical fiber of a fiber optic unit for transmitting light from a light source by an underside of a hob plate of the hob apparatus during an installation of the hob plate; and
deforming the optical fiber in an elastic manner by a subsequent lowering of the hob plate.
